(19) United States
(12) Patent Application Publication
(10) Pub. No.: US 2010/0333042 A1
(43) Pub. Date: Dec. 30, 2010

(54) DISPLAY DATA OUTPUT DEVICE

(75) Inventor: Tsuyoshi YOSHII, Osaka (JP)

Correspondence Address: McDERMOTT WILL & EMERY LLP, 600 13 th Street, N.W., Washington, DC, 20005-3096, US

(73) Assignee: PANASONIC CORPORATION, Osaka (JP)

(21) Appl. No.: 12/876,767

(22) Filed: Sep. 7, 2010

Related U.S. Application Data
(63) Continuation of application No. PCT/JP2009/000850, filed on Feb. 26, 2009.

(30) Foreign Application Priority Data
Mar. 12, 2008 (JP) 2008-062605

(51) Int. Cl. G06F 3/048

(52) U.S. Cl. 715/862; 715/764

(57) ABSTRACT

Provided is a display data output apparatus for outputting a display image to be displayed on a screen. In order to reduce a time until the displayed image is displayed after input is received from a user, the display data output apparatus assigns priorities to a plurality of display objects that each have a possibility of being displayed subsequent to a current display state based on a predetermined assignment method, and sequentially generates a plurality of display data pieces according to the priorities. For example, the display data pieces are generated, starting from the one that requires a long time to be generated.

This is a continuation of International Application PCT/JP2009/000850, with an international filing date of Feb. 26, 2009.

### TECHNICAL FIELD

The present invention relates to an apparatus for generating display data to display images.

### BACKGROUND ART

In recent years, various home appliances have become multifunctional, and consequently each of the home appliances is meeting various needs of users by implementing more and more functions. Some home appliances are more or less equipped with screens for displaying functions being carried out and so on. As home appliances have become multifunctional, data displayed on screens attached to such home appliances have become diverse.

Here, images displayed on a screen are switched by receiving input from a user via a remote controller and the like, and displayed images change according to the received input. One example of such images is a menu for carrying out the above-mentioned various functions.

In order to display images responding to instructions from a user immediately after input of the instructions is received, it is considered necessary to preliminarily prepare display data relating to instructions that have possibilities of being received from a user.

Patent Literature 1 discloses a technology of preliminarily obtaining display data of the target of a link included in a page displayed on the internet, and displaying the obtained display data when the link is selected.

### CITATION LIST

### [Patent Literature]

### [Patent Literature 1]

Japanese Patent Application Publication No. H09-231119

### SUMMARY OF INVENTION

### Technical Problem

However, when an enormous amount of display data is required to be prepared by the addition of multiple functions, all the required display data might not be prepared before input is received from a user. In addition, there may be cases where all the required display data might not be prepared because of a limitation of storage capacity. Such physical or time limitations can give rise to a bad response, that is, a response time between reception of input from a user and display of images can be increased.

The present invention has been achieved in view of the above problem, and aims to provide a display data output apparatus capable of improving the response time between reception of input from a user and display of images.

### Solution to Problem

In order to solve the above problem, one aspect of the present invention is a display data output apparatus comprising: a storage unit for storing therein one or more display data pieces; a priority assignment unit operable to assign priorities to identifiers that respectively identify candidate display data pieces, each of the candidate display data pieces having a possibility of being displayed subsequent to a current display data piece being displayed; a generation unit operable to generate the candidate display data pieces according to the priorities and store the generated candidate display data pieces in the storage unit, generating and storing one piece at a time; an input reception unit operable to receive input from a user; a determination unit operable to determine one of the identifiers based on the received input; and a display control unit operable to (i) when one of the candidate display data pieces identified by the determined identifier is stored in the storage unit at the time of receiving the input, read the one candidate display data piece from the storage unit and output the read one candidate display data piece, and (ii) when the one candidate display data piece is not stored in the storage unit at the time of receiving the input, generate and output the one candidate display data piece.

Here, the display data output apparatus may further comprises a transition table storage unit for storing therein a transition table in which each information piece showing a display state is associated with one or more of the identifiers, wherein the priority assignment unit determines, with reference to the transition table, the one or more of the identifiers.

Here, the storage unit may be a memory, and a speed of reading the one candidate display data piece from the storage unit and outputting the read one candidate display data piece is faster than a speed of generating and outputting the one candidate display data piece.

### Advantageous Effects of Invention

With the above-mentioned structure, the candidate display data pieces that each have the possibility of being displayed subsequent to the current display data piece can be determined and the candidate display data pieces can be sequentially generated according to the priorities assigned by the priority assignment unit. As a result, a possibility of promptly outputting images in response to input from a user can be enhanced, and reduction of a response between reception of input and display of images can be inhibited depending on assignment by the priority assignment unit.

Here, the priority assignment unit may assign the priorities based on data processing time information pieces each showing a data processing time required to generate a different one of the candidate display data pieces.

Here, the priority assignment unit may assign the priorities such that the candidate display data pieces that require longer data processing times are assigned higher priorities to be generated.

With the above-mentioned structure, the priority assignment unit can assign priorities based on times required to generate the candidate display data pieces. By preferentially generating the candidate display data pieces with longer time to be generated, a response, namely an average time till images to be displayed is displayed can be reduced.

Here, the user may use a pointing device to move a cursor displayed on a screen and perform the input, the input reception unit may receive, from the pointing device, input of values of coordinates on a screen where the cursor should be displayed, and the priority assignment unit may assign the priorities after determining, based on a path of the cursor moved by using the pointing device, one of the candidate display data pieces that has a highest possibility of being displayed subsequent to the current display data piece of all the candidate display data pieces.

An image displayed on a screen is, for example, a GUI (Graphical User Interface). By placing the cursor on the GUI with use of the pointing device, such as a remote controller and a mouse, and pressing a set button, a predetermined function can be carried out. The user moves the cursor with use of the pointing device in order to place the cursor on a GUI on which a desired menu is displayed and perform input for the next display. Since a GUI that is on the path to be taken by the cursor has a high possibility of being selected by the user, the GUI having a high possibility of being selected can be determined based on the path to be taken by the cursor, display data to be displayed after the GUI is selected can be preliminarily prepared, and the display data can be promptly output in response to input from the user with the structure.

Here, the user may use a direction key to move a cursor for selecting a GUI from among GUIs being displayed on a screen and perform the input, and the priority assignment unit may determine one of the GUIs that is on a path to be taken by the cursor moved with use of the direction key as a GUI that has a highest possibility of being displayed subsequent to the current display data piece of all the GUIs, and assign the priorities such that one of the identifiers that identifies the determined GUI is assigned a highest priority.

In addition to the pointing device, the cursor for selecting a GUI as described above may be moved by using up and down keys mounted on a remote controller.

The user moves the cursor with use of the direction key in order to place the cursor on a GUI on which a desired GUI is displayed. Since a GUI that is on the path to be taken by the cursor has a high possibility of being selected by the user, the GUI that has a high possibility of being selected can be determined based on the path to be taken by the cursor, display data to be displayed after the GUI is selected can be preliminarily prepared, and the display data can be promptly output in response to input from the user with the structure.

Here, the generation unit may store each of the generated candidate display data pieces in a compressed format.

With the above-mentioned structure, since each of the generated candidate display data pieces is stored in a compressed format, a capacity of the storage unit can be reduced. Although it is desired that the storage unit (i.e. memory) for storing display data be possible to be quickly accessed, such memory is often expensive. Furthermore, since a memory becomes expensive due to an increase in a memory capacity, it is desired that a capacity of the storage unit be small. This structure can satisfy the above-mentioned wishes.

### BRIEF DESCRIPTION OF DRAWINGS

FIG. 1 is a functional block diagram showing a functional structure of a display data output apparatus 100.

FIG. 2 shows that a display state can transition from one state to a plurality of states. FIG. 3 is a conceptual diagram showing a data structure of a transition table 111.

FIG. 4 is a conceptual diagram showing a data structure of a processing time table 112.

FIG. 5 is a conceptual diagram of a display command processed by the display data output apparatus 100.

FIG. 6 is a conceptual diagram showing a data structure of a display basic data table 113.

FIG. 7 is a flow chart showing operation of the display data output apparatus 100 when the display data output apparatus 100 prepares display data.

FIG. 8 is an example of an image displayed on a screen in Embodiment 2 and shows movement of a cursor.

FIG. 9 is a flow chart showing operation of the display data output apparatus 100 when the display data output apparatus 100 in Embodiment 2 prepares display data.

FIG. 10 is an example of an image displayed on a screen in Embodiment 3.

FIG. 11 is a flow chart showing operation of the display data output apparatus 100 when the display data output apparatus 100 in Embodiment 3 prepares display data.

### DESCRIPTION OF EMBODIMENTS

A display data output apparatus in embodiments of the present invention is described below with reference to the drawings.

### Embodiment 1

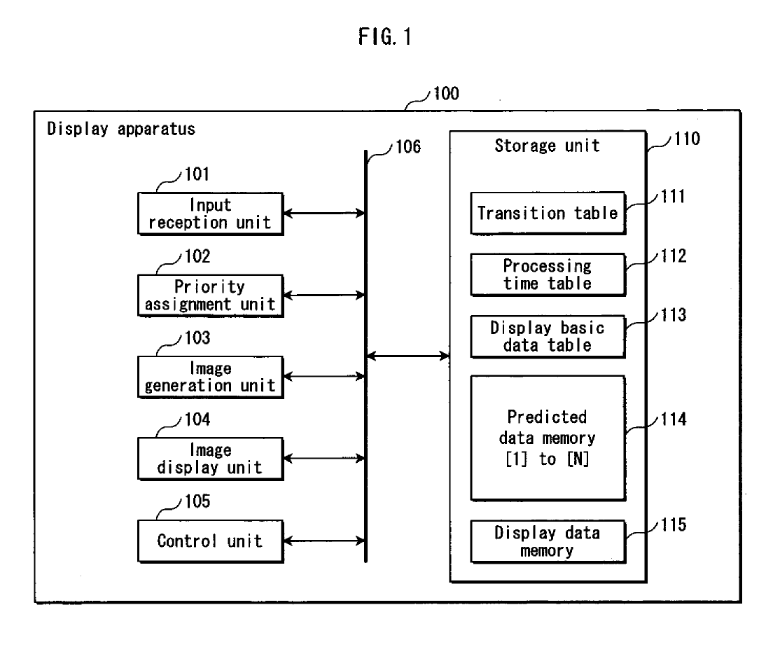

FIG. 1 is a functional block diagram showing a functional structure of a display data output apparatus 100.

As shown in FIG. 1, the display data output apparatus 100 includes an input reception unit 101, a priority assignment unit 102, an image generation unit 103, an image display unit 104, a control unit 105, and a storage unit 110. These units in the display data output apparatus 100 are connected with one another via a bus 106.

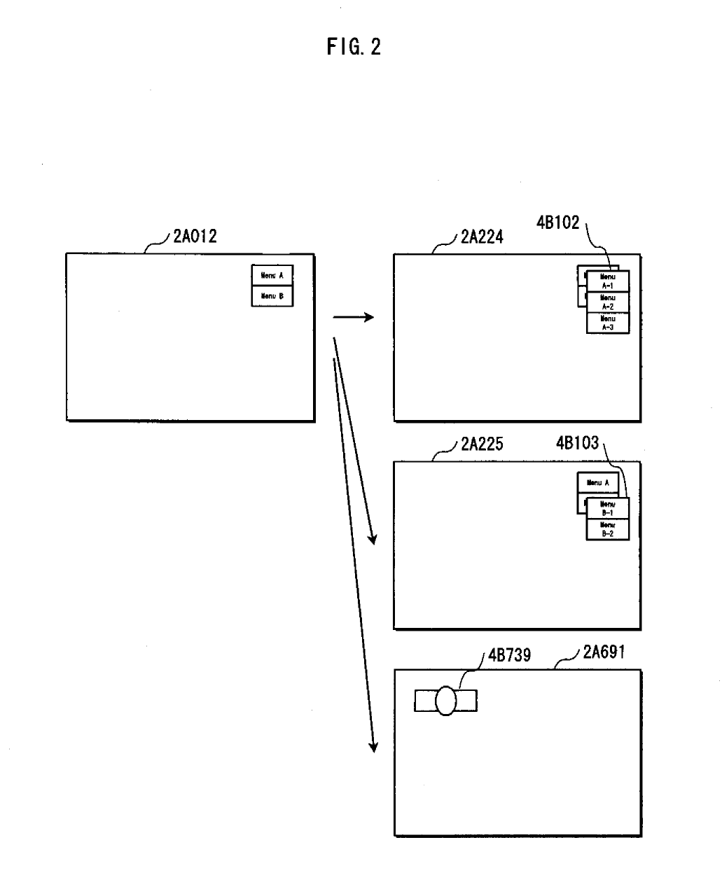

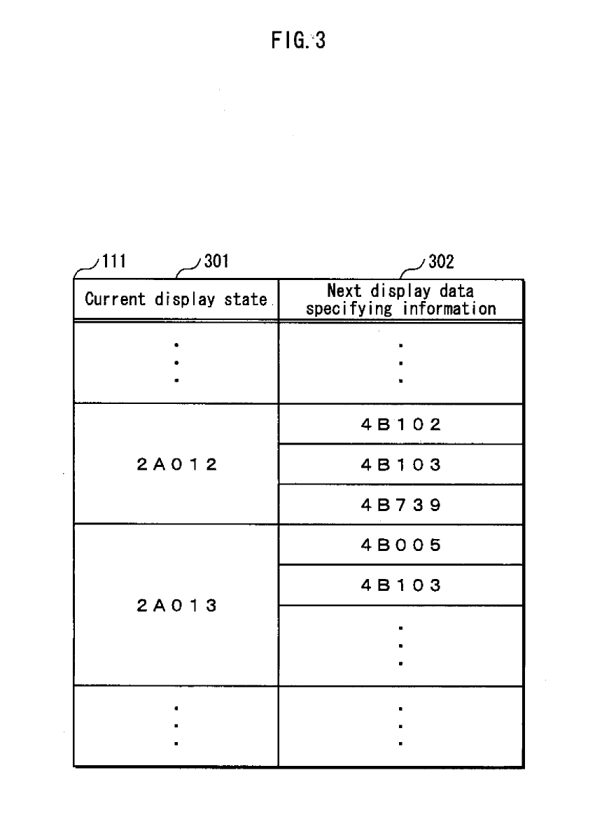

When there are a plurality of display states that can be displayed subsequent to a certain display state, the display data output apparatus 100 selects display state that should be preferentially prepared from among the plurality of display states, and generates display data for the selected display state first. FIG. 2 is a specific example showing that there are a plurality of display states that can be displayed subsequent to a certain display state. As shown in FIG. 2, a display state “2A012” can transition to one of display states “2A224”, “2A225”, and “2A691” in response to input from a user. Display data specified by display data specifying information “4B102” is required to realize the display state “2A224”. Display data specified by display data specifying information “4B103” and display data specified by display data specifying information “4B739” are required to realize the display states “2A225” and “2A691”, respectively. In Embodiment 1, from among display data pieces specified by display data specifying information pieces “4B102”, “4B103”, and “4B739”, the display data output apparatus 100 generates display data pieces, starting from the one that requires along time for generation.

The following describes a function of each functional unit included in the display data output apparatus 100 to realize the above-mentioned processing, with use of FIG. 1.

The input reception unit 101 receives input of infrared light from a user via a remote controller (not illustrated) corresponding to the display data output apparatus 100, and outputs the received input to the control unit 105.

The priority assignment unit 102 assigns priorities to display data specifying information pieces respectively specifying display data pieces that each can be displayed subsequent to a current display state, and notifies the control unit 105 of the priorities.

The image generation unit 103 generates images based on instructions from the control unit 105, and stores the generated images in a predicted data memory 114 or a display data memory 115 in the storage unit 110.

The image display unit 104 includes a screen. The image display unit 104 reads out display data from the display data memory 115 to display images in accordance with instructions from the control unit 105. Additionally, the image display unit 104 reads out display data from an address on the predicted data memory 114 specified by the control unit 105 to display images in accordance with instructions from the control unit 105.

The control unit 105 controls each unit in the display data output apparatus 100. The control unit 105 is a processer, and controls the display data output apparatus 100 by using various programs and data pieces stored in the storage unit 110.

Specifically, the control unit 105 analyses input received by the input reception unit 101. Based on the analysis, the control unit 105 judges whether display data to be displayed is stored in the predicted data memory 114 or not. When the display data to be displayed is stored in the predicted data memory 114, the control unit 105 transmits, to the image display unit 104, an address on the predicted data memory 114 at which the display data to be displayed is stored. When the display data to be displayed is not stored in the predicted data memory 114, the control unit 105 instructs the image generation unit 103 to generate display data for displaying a display object corresponding to the input received by the input reception unit 101. As a result, the image generation unit 103 generates the instructed display data and stores the generated display data in the display data memory 115, and the image display unit 104 outputs the display data stored in the display data memory 115 after reading out the display data.

The storage unit 110 is realized by a hard disk drive, various memories and the like. The storage unit 110 stores programs and data pieces required for the display data output apparatus 100 to operate. The storage unit 110 stores a transition table 111, a processing time table 112, and a display basic data table 113.

The transition table 111 is used by the display data output apparatus 100 to search for display data pieces that each can be displayed subsequent to a current display data piece. The processing time table 112 shows a time required to generate each display data piece. The display basic data table 113 shows basic data pieces for generating each display data piece. Details of these tables are described later.

Furthermore, the storage unit 110 includes the predicted data memory 114 and the display data memory 115. The predicted data memory 114 and the display data memory 115 are both realized by a high-speed memory such as a cache memory. The predicted data memory 114 stores a display data piece that should be displayed subsequent to a current display data piece by the display data output apparatus 100. On the other hand, the display data memory 115 stores a display data piece that is generated when the display data piece that should be displayed subsequent to the current display data piece is not stored in the predicted data memory 114. Note that, since a plurality of display data memories are stored in the predicted data memory 114, numbers “[1] to [N]” are appended to the predicted data memory 114 in FIG. 1. Here, N indicates an integer equal to or greater than 2, and shows the number of stored display data memories.

(Data)

The following describes data and the like stored in the display data output apparatus 100 of the present invention.

The transition table 111 is described first. The transition table 111 shows data pieces required in display states that each can be displayed after a current display state. FIG. 3 conceptually shows a data structure of the transition table 111.

As shown in FIG. 3, the transition table 111 includes a current display state column 301 and a next display data specifying information column 302. The current display state 301 column and the next display data specifying information column 302 are associated with each other. For example, display objects required in display states that each can be displayed after a current display state “2A012” are “4B102”, “4B103”, and “4B739”.

The current display state column 301 includes an identifier that is required for the display data output apparatus 100 to identify a display state uniquely determined by a display object currently being displayed.

The next display data specifying information column 302 includes an identifier identifying a display object that is required in each display state that can be displayed subsequent to a current display object.

This concludes a description of the transition table 111.

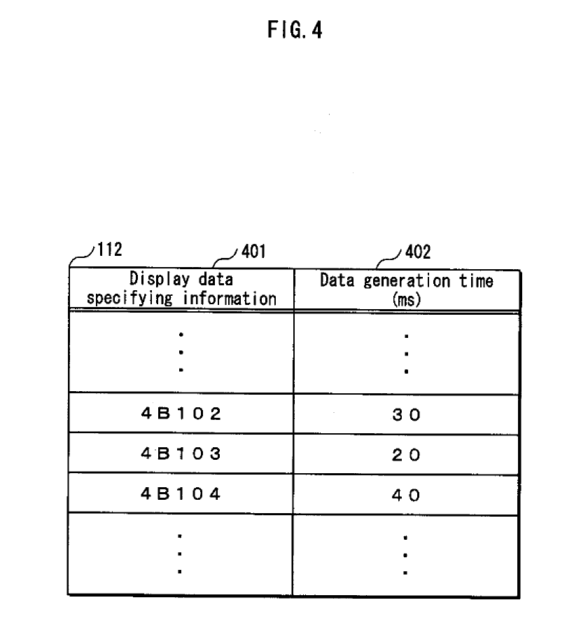

The processing time table 112 shows a time required to generate each display data piece. FIG. 4 conceptually shows a data structure of the processing time table 112.

As shown in FIG. 4, the processing time table 112 includes a display data specifying information column 401 and a data generation time column 402. The display data specifying information column 401 and the data generation time column 402 are associated with each other. For example, a processing time required to generate a display object “4B103” is “20 ms”.

The display data specifying information column 401 includes an identifier for identifying a display object.

The data generation time column 402 includes information about a time required to generate a display data piece that is necessary for displaying each display object.

This concludes a description of the processing time table 112.

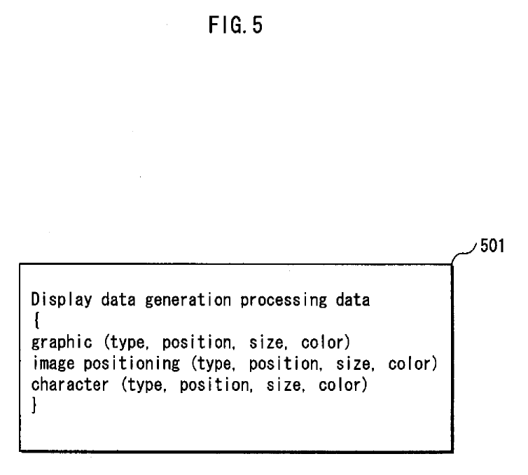

Before the display basic data table 113 is described, a command used by the display data output apparatus 100 to generate display data is described with use of FIG. 5.

FIG. 5 conceptually shows a structure of a command 501. Commands for rendering a graphic, positioning an image, and writing a character are included in OSD generation processing data.

The command for rendering a graphic includes information about a type of a graphic, a display position of a graphic, a size of a graphic, a color of a graphic and the like. The type of a graphic is, for example, a rectangle, a circle, an ellipse, a line segment, and so on. The display position of a graphic includes information showing coordinates on a screen at which the graphic is displayed. The size of a graphic includes information for determining a size of a graphic to be displayed. For example, when the graphic is a circle, the size of a graphic is shown by a length of a diameter of the circle. The color of a graphic includes information about a color of a graphic to be displayed, and is shown, for example, by an RGB model.

The command for positioning an image is used for reading out a preliminarily prepared image from a hard disk and the like, and storing the read out image in the predicted data memory 114 or the display data memory 115. The command for positioning an image includes information about a type of a read out image, a display position of a readout image, a display size of a read out image, a display color of a read out image and the like.

The command for writing a character (e.g. a letter) includes information about contents of a character, a display position of a character, a size of a character, a color of a character and the like. The contents of a character include information about a character that is actually displayed. The display position of a character includes information showing coordinates on a screen at which the character is displayed. The size of a character includes information for determining a font size of the character to be displayed. The color of a character includes information about a color of the character to be displayed, and is shown, for example, by an RGB model.

The following describes the display basic data table 113.

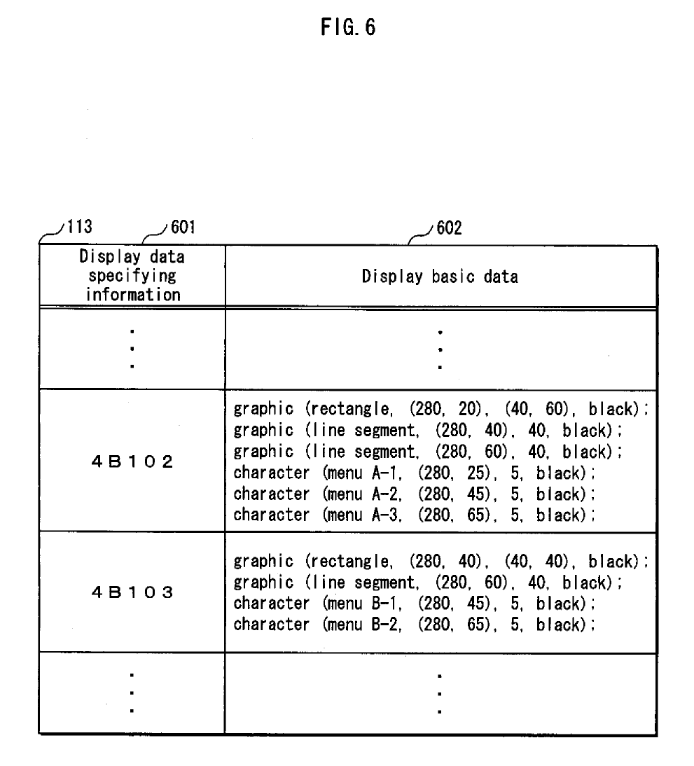

The display basic data table 113 includes information showing basic data for generating display data that is required to display each display object. FIG. 6 conceptually shows a data structure of the display basic data table 113.

As shown in FIG. 6, the display basic data table 113 includes a display data specifying information column 601 and a display basic data column 602. The display data specifying information column 601 and the display basic data column 602 are associated with each other. For example, display basic data required to display a display object “4B102” is “graphic (rectangle, (280, 20), (40, 60), black) ; graphic (line segment, (280, 40), 40, black); graphic (line segment, (280, 60), 40, black); character (menu-A-1, (280, 25), 5, black); character (menu-A-2, (280, 45), 5, black) ; character (menu-A-3, (280, 65), 5, black);”. Note that coordinates here are those on a screen, and sizes are shown in a unit based on the coordinates.

The following describes how display data is generated by a rendering command with use of the above-mentioned specific example.

When a rendering command is “graphic (rectangle, (280, 20), (40, 60), black)”, display data for drawing a 40×60 rectangle whose rendering start coordinates are (280, 20) is generated. Here, the rendering start position is a top left point of a minimum square that can enclose the whole graphic.

When a rendering command is “character (menu-A-2, (280, 45), 5, black)”, characters “menu-A-2” whose rendering start coordinates are (280, 45) is written in black with a character font size 5.

The display data specifying information column 601 includes an identifier that is required for the display data output apparatus 100 to identify display data.

The display basic data column 602 includes information about basic data for generating display data of each display object.

(Operation)

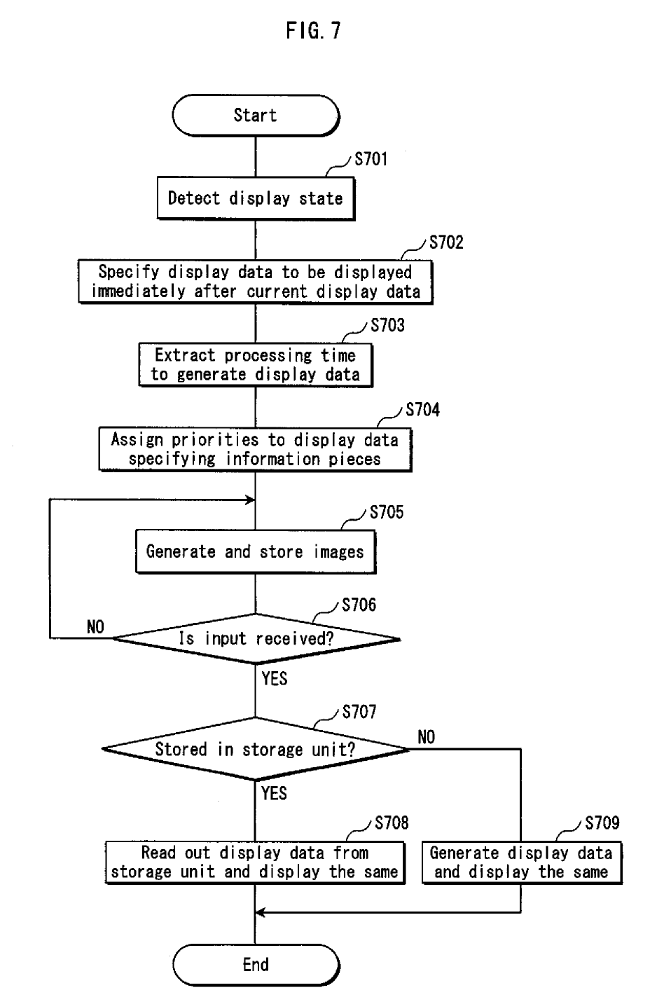

The following describes operation in this embodiment with use of a flow chart shown in FIG. 7.

FIG. 7 shows operation of the display data output apparatus 100 from reception of input from a user to the next reception of input.

First, the control unit 105 in the display data output apparatus 100 detects a display state (step S701). The display state can be detected from display data currently being displayed by the display data output apparatus 100.

The control unit 105 obtains, from the transition table 111, display data specifying information pieces respectively specifying display data pieces that each can be displayed subsequent to the display data currently being displayed based on a current display state (step S702).

Then, the control unit 105 obtains, from the processing time table 112, processing times to generate the display data pieces specified by the extracted display data specifying information pieces (step S703).

The control unit 105 outputs the extracted processing times to the priority assignment unit 102. The priority assignment unit 102 assigns priorities to the display data specifying information pieces according to the transmitted processing times, such that display data specifying information pieces that specify display data pieces requiring longer time for generation are assigned higher priority. Then, the priority assignment unit 102 transmits the priorities to the image generation unit 103 (step S704).

The image generation unit 103 generates, with use of the display basic data table 113, display data pieces that have not yet been stored in the predicted data memory 114 and have been specified by display data specifying information pieces assigned the higher priority based on the priorities transmitted by the priority assignment unit 102, and stores the generated display data pieces in the predicted data memory 114 (step S705).

Here, the control unit 105 detects whether the input reception unit 101 has received input from a user by detecting whether a signal has been transmitted from the input reception unit 101 (step S706). Unless input is received from a user (NO in step S706), the processing returns to step S704, and the display data output apparatus 100 performs the subsequent processing.

On the other hand, when receiving input from a user (YES in step S706), the input reception unit 101 transmits the received input to the control unit 105. The control unit 105 detects whether display data to be displayed in response to the input received by the input reception unit 101 is stored in the predicted data memory 114 or not (step S707).

After the detection, when the display data to be displayed in response to the input received by the input reception unit 101 is stored in the predicted data memory 114 (YES in step S707), the control unit 105 specifies an address on the predicted data memory 114 at which the display data is stored. The image display unit 104 outputs the display data stored at the specified address to display the same on a screen (step S708).

On the other hand, after the detection, when the display data to be displayed in response to the input received by the input reception unit 101 is not stored in the predicted data memory 114 (NO in step S707), the control unit 105 instructs the image generation unit 103 to generate display data corresponding to the received input. The image generation unit 103 stores the generated display data in the display data memory 115. Then, the control unit 105 instructs the image display unit 104 to read out the display data from the display data memory 115. The image display unit 104 outputs the display data after reading out the display data from the display data memory 115 and displays images on a screen.

The following describes the above operation by using a case shown in FIG. 2 as a specific example. As shown in FIG. 2, it is presumed that there are three display states “2A224”, “2A225”, and “2A691” to which a display state “2A012” can transition by receiving input from a user.

Display data specified by display data specifying information “4B102” is required for transitioning from the display state “2A012” to the display state “2A224”. Display data specified by display data specifying information “4B103” and display data specified by display data specifying information “4B739” are required for transitioning to the display state “2A225” and the display state “2A691”, respectively. As can be seen from the processing time table 112, “30 ms” and “20 ms” are required for generating display data pieces specified by the display data specifying information pieces “4B102” and “4B103”, respectively. Although not being illustrated, it is presumed here that “60 ms” is required for generating display data specified by the display data specifying information “4B739”. In this case, the priority assignment unit 102 assigns priorities to the three display data specifying information pieces “4B739”, “4B102”, and “4B103” in this order. The image generation unit 103 generates display data pieces specified by the display data specifying information pieces in the above-mentioned order, and stores the generated display data pieces in the predicted data memory 114.

By preparing display data pieces, starting from the one that requires a long time for generation in the above-mentioned operation, the display data output apparatus 100 can reduce an average time required to respond to input from a user.

### Embodiment 2

In the above-mentioned Embodiment 1, an order in which display data pieces that each can be displayed subsequent to a current display data piece are generated is determined based on processing times. In Embodiment 2, the order in which the display data pieces are generated is determined based on movement of a cursor.

(Structure)

Here, since a structure of the display data output apparatus is approximately the same as that shown in Embodiment 1, only a function that is different from that in Embodiment 1 is explained.

The input reception unit 101 receives input via a pointing device such as a remote controller, and transmits position coordinates of a cursor displayed on a screen to the control unit 105.

In contrast to the priority assignment unit 102 in Embodiment 1, the priority assignment unit 102 in this embodiment assigns priorities to display data specifying information pieces such that display data for displaying a display object specified by the control unit 105 is preferentially prepared, and transmits the priorities to the image generation unit 103.

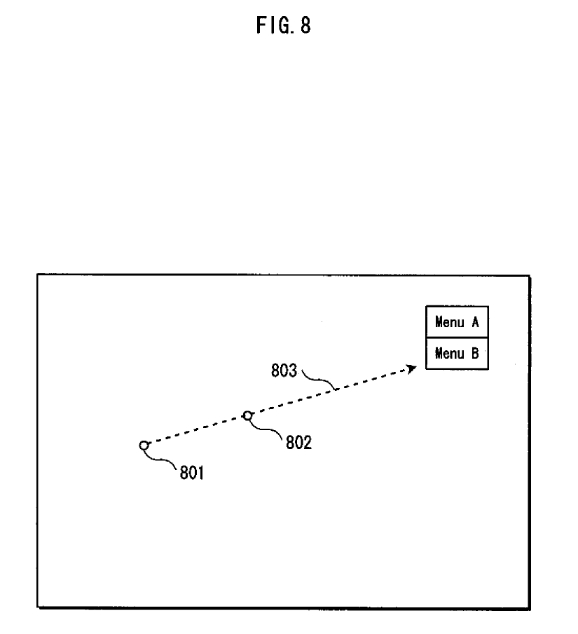

In addition to functions shown in Embodiment 1, the control unit 105 calculates a line passing through two coordinates of a cursor that are transmitted by the input reception unit 101, and determines whether the line intersects with any selectable GUI that is located in a direction of movement of a cursor. FIG. 8 shows an example of an image displayed on a screen. This function is specifically described with use of FIG. 8.

FIG. 8 is one example of images displayed on a screen attached to the display data output apparatus 100. It is presumed here that a cursor 801 is displayed at a time t, and a cursor 802 is displayed at a time t+1, which is after the time t. Since a user uses a pointing device for input, it can be assumed that the user moves a cursor to select a menu that is on an extended line along a direction of the movement.

Therefore, based on basic data pieces used to display two GUIs “Menu A” and “Menu B” on a display screen in FIG. 8, coordinate ranges of the two GUIs are identified.

Then, whether a line that is shown by a broken arrow line 803 in FIG. 8 intersects with the identified coordinate ranges is judged. In FIG. 8, the broken arrow line 803 is intersecting with “Menu B”. Therefore, the display data output apparatus 100 more preferentially generates display data that should be displayed when “Menu B” is selected than display data that should be displayed when “Menu A” is selected.

(Operation)

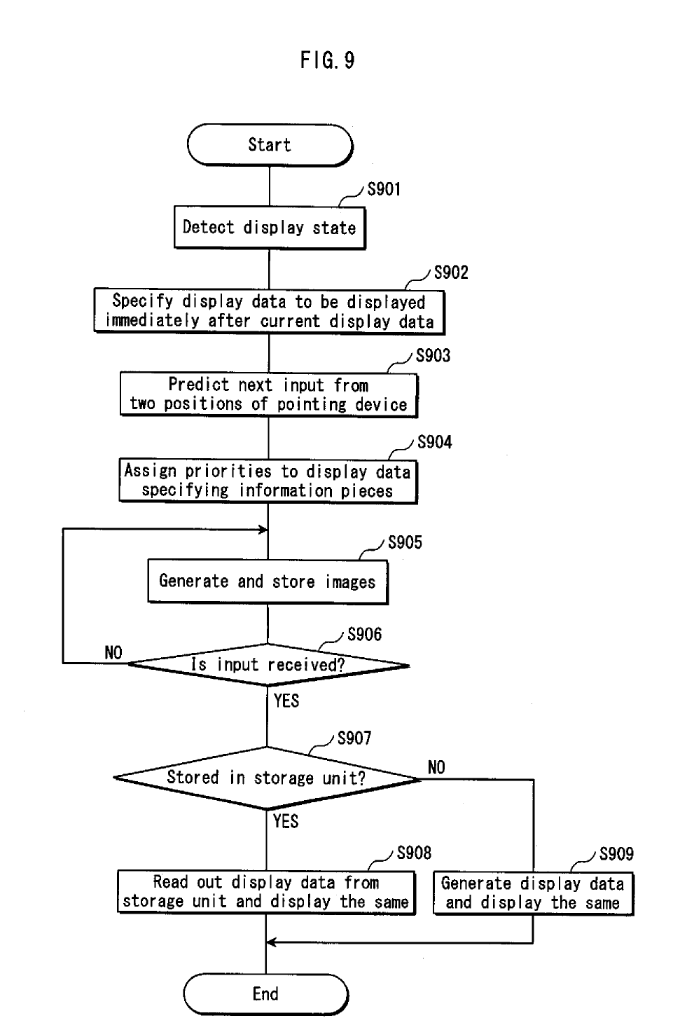

FIG. 9 is a flow chart showing operation of the display data output apparatus 100 pertaining to Embodiment 2. By taking steps S901 to S909 in FIG. 9, the display data output apparatus 100 can output display data that should be displayed in response to input from a user more promptly than before.

The operation is approximately the same as that shown in FIG. 7 in Embodiment 1. The operation in this embodiment differs from that in Embodiment 1 in step S703 in FIG. 7. Therefore, operation in step S903, which corresponds to step S703 in Embodiment 1, is mainly described here.

In step S903, the control unit 105 calculates a line passing through two coordinates of a cursor that are transmitted by the input reception unit 101. Next, the control unit 105 calculates, by referring to display basic data, a coordinate range in which each GUI is displayed based on display data being displayed.

Then the control unit 105 judges whether or not the calculated line intersects with any of the calculated coordinate ranges.

When the calculated line intersects with any of the calculated coordinate ranges, the control unit 105 transmits display data specifying information specifying a GUI that is in the intersected coordinate range to the priority assignment unit 102. When the calculated line intersects with a plurality of coordinate ranges, the control unit 105 transmits a plurality of display data specifying information pieces each specifying a GUI to the priority assignment unit 102 such that display data pieces whose position are closer to the detected coordinates of a cursor are preferentially prepared.

The priority assignment unit 102 assigns priorities to display data specifying information pieces such that display data that is specified by the display data specifying information transmitted by the control unit 105 is preferentially generated (step S904), and transmits the prioritized display data specifying information pieces to the image generation unit 103. Then, the display data output apparatus 100 performs the subsequent processing.

Note that operation in the other steps is the same as that in Embodiment 1 as described above.

### Embodiment 3

In the above-mentioned Embodiment 1, an order in which display data pieces that each can be displayed subsequent to a current display data piece are generated is determined based on processing times. In Embodiment 3, the order in which the display data pieces are generated is determined based on movement of a cursor that occurs by a user pressing a direction key.

(Structure)

Here, since a structure of the display data output apparatus is approximately the same as that shown in Embodiment 1, only a function that is different from that in Embodiment 1 is explained.

In contrast to the priority assignment unit 102 in Embodiment 1, the priority assignment unit 102 in this embodiment assigns priorities to display data specifying information pieces such that display data for displaying a display object specified by the control unit 105 is preferentially prepared, and transmits the priorities to the image generation unit 103.

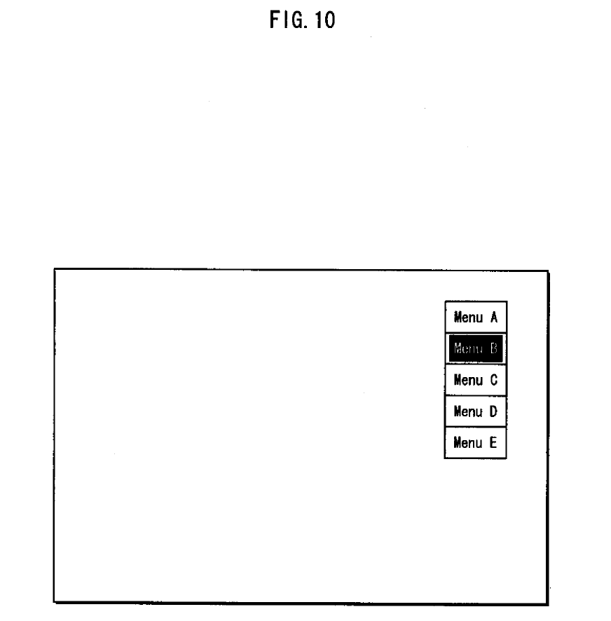

In addition to functions shown in Embodiment 1, the control unit 105 detects movement of a cursor from input of up and down keys transmitted by the input reception unit 101. The control unit 105 transmits, to the priority assignment unit 102, display data specifying information for specifying display data that is required when a GUI on an extended line along a direction of the movement of a cursor is selected by a user pressing the up and down keys, starting from the one whose position is closest to coordinates of the cursor. FIG. 10 shows an example of an image displayed on a screen. This function is specifically described with use of FIG. 10.

FIG. 10 is an image displayed on a screen at a certain point of time. As shown in FIG. 10, Menus A to E are displayed on the screen. A position of a cursor is shown by highlighting characters on which the cursor is placed. In FIG. 10, “Menu B” is highlighted, and is in a selectable state.

In this state, it is considered that the cursor is moved to “Menu A” by receiving input “up” from a user, or the cursor is moved to “Menu C” or one of menus below “Menu C” by receiving input “down” from the user. If the input “up” is received, it is highly possible that “Menu A” is selected. On the other hand, if the input “down” is received, it is highly possible that “Menu C” or one of menus below “Menu C” is selected.

Therefore, if the input “up” is received in the state shown in FIG. 10, the display data output apparatus 100 generates display data of a display object that should be displayed when “Menu A” is selected before generating display data of a display object that should be displayed when “Menu C” or one of menus below “Menu C” is selected. On the other hand, if the input “down” is received in the state shown in FIG. 10, the display data output apparatus 100 generates the display data of a display object that should be displayed when “Menu C” or one of menus below “Menu C” is selected before generating display data of a display object that should be displayed when “Menu A” is selected.

(Operation)

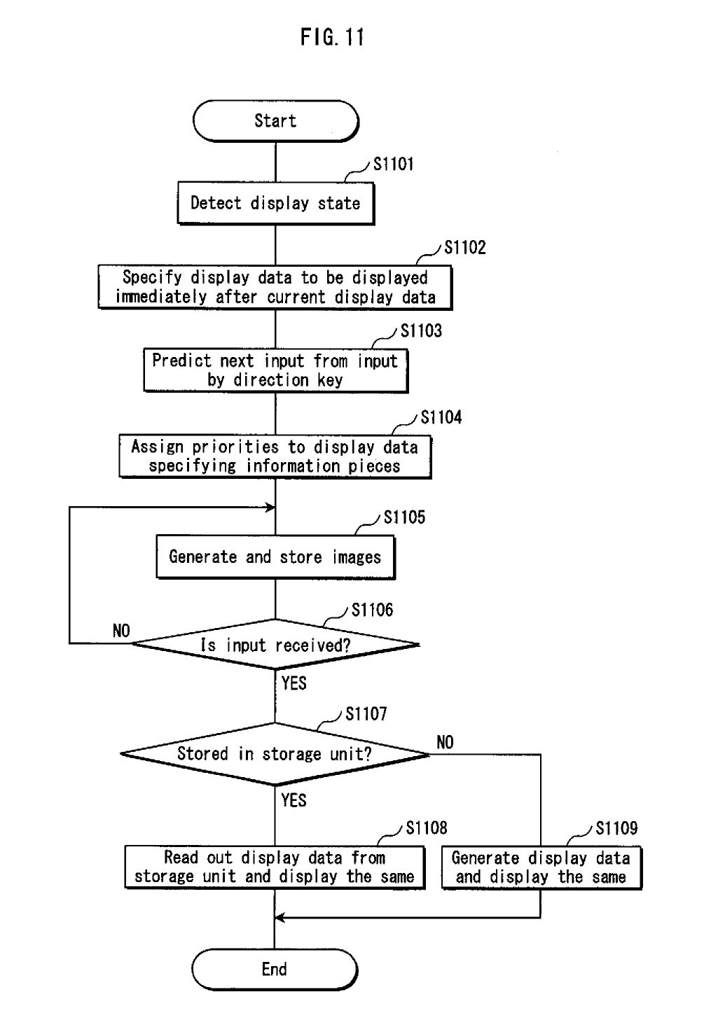

FIG. 11 is a flow chart showing operation of the display data output apparatus 100 pertaining to Embodiment 3. By taking steps S1101 to S1109 in FIG. 11, the display data output apparatus 100 can output display data that should be displayed in response to input from a user more promptly than before.

The operation is approximately the same as that shown in

FIG. 7 in Embodiment 1. The operation in this embodiment differs from that in Embodiment 2 in step S703 in FIG. 7. Therefore, operation in step S1103, which corresponds to step S703 in Embodiment 1, is mainly described here.

In step S1103, the control unit 105 calculates a line passing through two coordinates of a cursor that are transmitted by the input reception unit 101. Next, the control unit 105 calculates, by referring to display basic data, a coordinate range in which each GUI is displayed based on display data being displayed.

Then the control unit 105 judges whether or not the calculated line intersects with any of the calculated coordinate ranges.

When the calculated line intersects with any of the calculated coordinate ranges, the control unit 105 transmits display data specifying information specifying a GUI that is in the intersected coordinate range to the priority assignment unit 102. When the calculated line intersects with a plurality of coordinate ranges, the control unit 105 transmits a plurality of display data specifying information pieces each specifying a GUI to the priority assignment unit 102 such that display data pieces whose position are closer to the detected coordinates of a cursor are preferentially prepared.

The priority assignment unit 102 assigns priorities to display data specifying information pieces such that display data that is specified by the display data specifying information transmitted by the control unit 105 is preferentially generated (step S1104), and transmits the prioritized display data specifying information pieces to the image generation unit 103.

Note that operation in the other steps is the same as that in Embodiment 1 as described above.

(Modifications)

The present invention has been explained in accordance with the above embodiments, however it is obvious that the present invention is not limited to the above embodiments. The following modifications are also within the scope of the present invention.

(1) In the above embodiments, although the display data output apparatus 100 includes a screen, the display data output apparatus 100 may be an apparatus for outputting display data. When a screen is provided outside the display data output apparatus 110, the image display unit 104 outputs display data to the outside screen.

(2) In the above embodiments, although the input reception unit 101 receives input of infrared light via a remote controller, the input reception unit 101 may receive input via any input device such as a cross key, a ten key, and a character input key provided to the display data output apparatus through which a user can issue instructions.

(3) In the above embodiments, although the input reception unit 101 is included in the display data output apparatus 100, the input reception unit 101 may be provided outside the display data output apparatus 100 and the display data output apparatus 100 may receive a signal showing input from a user.

(4) In the above embodiments, although a screen is provided inside the display data output apparatus 100, the display data output apparatus 100 may be an apparatus for at least preliminarily preparing display data and outputting the display data. The display data output apparatus 100 may not include a screen, and, for example, output display data to a monitor connected to the display data output apparatus 100.

(5) In the above Embodiment 2, display data of a GUI that is on an extended line connecting two points is preferentially prepared. As long as a point to which a cursor is moved can be predicted based on movement of the cursor that occurs by input from a user, a method for preparing display data is not limited to this. For example, a quadratic curve derived from several coordinates may be calculated. When a locus of the quadratic curve on a screen intersects with any GUI, display data that is required when the intersected GUI is selected may be preferentially prepared.

(6) In the above Embodiment 3, although a cursor is moved by using up and down keys, the cursor may be moved by using right and left keys. Furthermore, although a plurality of selectable GUIs are simply longitudinally arranged in FIG. 10 in the above Embodiment 3, menus may be placed everywhere on a screen as long as the menus can be selected by moving a cursor with use of up and down keys or right and left keys.

(7) In the above embodiments, although different methods for assigning priorities are shown, these methods may be combined with one another. For example, display data required when a GUI that is on predicted point to which a cursor is moved is selected may be assigned a highest priority, and display data pieces that are not relevant to the predicted point may be assigned priorities based on times required to be generated.

(8) In the above embodiment, although display data pieces that each can be displayed subsequent to a current display data piece are prepared, other display data pieces that can be displayed after the display data pieces may be prepared as long as the display data output apparatus 100 has adequate performance and storage capacity.

(9) Although not specifically described in the above embodiments, display data may be stored in the predicted data memory 114 in a compressed format. When a time required for decoding compressed data to output display data and a time for generating display data to output the display data are compared, the time for decoding compressed data to output display data is shorter than the time for generating display data to output the display data. Furthermore, by storing display data in a compressed format, capacity of the predicted data memory 114 can be reduced compared with that shown in the above embodiments.

(10) A control program including a program code for causing a processor in the display data output apparatus and various circuits connected to the processor to perform processing shown in the above embodiments (i.e. processing of preliminarily preparing display data pieces that each can be displayed subsequent to a current display data piece before receiving input from a user) may be recorded on a recording medium or distributed via various communication channels. Such recording medium is, for example, an IC card, a hard disk, an optical disc, a flexible disc, a ROM. The distributed control program is used by being stored in a memory and so on that can be read by a processor, and each function shown in the above embodiments can be fulfilled by the processor executing the control program.

(11) Each functional unit shown in the above embodiments may be realized by one or a plurality of LSIs (Large Scale Integration). Alternatively, a plurality of functional units maybe realized by an LSI. Although an LSI is taken as an example here, an LSI is referred to as an IC (integrated Circuit), a system LSI, a super LSI, an ultra LSI depending on the integration degree, and thus these may be used instead of the LSI.

### INDUSTRIAL APPLICABILITY

A display data output apparatus of the present invention can be broadly used in a home appliance and so on as an apparatus capable of speeding up image display in response to input from a user.

### REFERENCE SIGNS LIST

100 display data output apparatus

101 input reception unit

102 priority assignment unit

103 image generation unit

104 image display unit

105 control unit

106 bus

110 storage unit

111 transition table

112 processing time table

113 display basic data table

114 predicted data memory

115 display data memory

1. A display data output apparatus comprising:
a storage unit for storing therein one or more display data pieces;
a priority assignment unit operable to assign priorities to identifiers that respectively identify candidate display data pieces, each of the candidate display data pieces having a possibility of being displayed subsequent to a current display data piece being displayed;
a generation unit operable to generate the candidate display data pieces according to the priorities and store the generated candidate display data pieces in the storage unit, generating and storing one piece at a time;
an input reception unit operable to receive input from a user;
a determination unit operable to determine one of the identifiers based on the received input; and
a display control unit operable to (i) when one of the candidate display data pieces identified by the determined identifier is stored in the storage unit at the time of receiving the input, read the one candidate display data piece from the storage unit and output the read one candidate display data piece, and (ii) when the one candidate display data piece is not stored in the storage unit at the time of receiving the input, generate and output the one candidate display data piece.

2. The display data output apparatus of claim 1, wherein
the priority assignment unit assigns the priorities based on data processing time information pieces each showing a data processing time required to generate a different one of the candidate display data pieces.

3. The display data output apparatus of claim 2, wherein
the priority assignment unit assigns the priorities such that the candidate display data pieces that require longer data processing times are assigned higher priorities to be generated.

4. The display data output apparatus of claim 1, wherein
the user uses a pointing device to move a cursor displayed on a screen and perform the input,
the input reception unit receives, from the pointing device, input of values of coordinates on a screen where the cursor should be displayed, and
the priority assignment unit assigns the priorities after determining, based on a path of the cursor moved by using the pointing device, one of the candidate display data pieces that has a highest possibility of being displayed subsequent to the current display data piece of all the candidate display data pieces.

5. The display data output apparatus of claim 1, wherein
the user uses a direction key to move a cursor for selecting a GUI from among GUIs being displayed on a screen and perform the input, and
the priority assignment unit determines one of the GUIs that is on a path to be taken by the cursor moved with use of the direction key as a GUI that has a highest possibility of being displayed subsequent to the current display data piece of all the GUIs, and assigns the priorities such that one of the identifiers that identifies the determined GUI is assigned a highest priority.

6. The display data output apparatus of claim 1, wherein
the generation unit stores each of the generated candidate display data pieces in a compressed format.

7. The display data output apparatus of claim 1 further comprising
a transition table storage unit for storing therein a transition table in which each information piece showing a display state is associated with one or more of the identifiers, wherein
the priority assignment unit determines, with reference to the transition table, the one or more of the identifiers.

8. The display data output apparatus of claim 1, wherein
the storage unit is a memory, and a speed of reading the one candidate display data piece from the storage unit and outputting the read one candidate display data piece is faster than a speed of generating and outputting the one candidate display data piece.
